(19) United States
(12) Patent Application Publication
(10) Pub. No.: US 2009/0302615 A1
(43) Pub. Date: Dec. 10, 2009

(54) Hidroflot

(76) Inventor: Pedro Antonio Padilla Correa, Iquitos (PE)

Correspondence Address: Pedro Antonio Padilla Correa, 14628 Elaine Ave., Norwalk, CA, 90650, US

(21) Appl. No.: 12/157,131

(22) Filed: Jun. 9, 2008

(51) Int. Cl. F03G 7/10

(52) U.S. Cl. 290/1 R; 74/DIG. 9

(57) ABSTRACT

The energy generator system is made up of eight attached floaters with the same amount of break-away mechanical arms connected to a central shaft, all located in a circular position. The entire system is within a container of water that keeps the water level at ⅘ parts of its capacity or in the same amount that is ⅕ part over of the shaft.

Constant rotation is obtained by the floaters attached to the ends of the extended mechanical arms (three arms are permanently attached to the extended arms, five are attached to the folded arms and while one arm is displaced from the water it is replaced by another that enters with the break-away arm) due to the fact that the arms are longer and are in an extended position, in relation to the way the folded arms develop greater force than these and are able to restore them to the water so that at a certain time, where they must be able to gain force upon displacement, the arms will extend and continue with the cycle. The simplicity of this system is that it does not need any other type of force to stimulate it. It does not require another form of energy, and it can function permanently without creating heavy noise or contamination because it solely relies on water in a container.

### BACKGROUND OF THE INVENTION

In order to generate rotation, the device applies energy from the propeller produced by compressed air displaced out of water. This distinguishes it as an important mechanical instrument capable of restoring the compressed air into the water once more which was initially displaced but using less force returning it to starting point, completing the displacement cycle-back to starting point.

### SUMMARY OF THE INVENTION

The objective of this invention is to rely on a mechanical means that will utilize energy for its rotation arising from the displacement between water and air therefore not creating pollution or heavy noise. Essentially the energy generator will be inexpensive and everlasting and will be a source of alternative energy to those that already exist.

When connecting the device to a dynamo it becomes an electrical generator.

In order for the device to rotate on its shaft it applies the power of three of the eight floaters attached to the same amount of mechanical arms made up of hooks and springs. The beginning is basic; when two arms are aligned (left and right side of the shaft) and immersed in the water, the arm that will come out is extended while the arm ready to enter is folded back (long arm dominates short arm).

Upon reaching a central point in which the device must float, the folded arm extends out taking advantage of the traction's force. This is exerted by the projecting arms that are always in the same position and location, three at a time (when one arm disappears at the top, another arm replaces that one at the bottom at starting point.

### BRIEF DESCRIPTION OF THE DRAWING

FIG. 1 is a front perspective view of the present invention.

FIG. 2 is an exploded view of the mechanical arm of the present invention.

FIG. 3 is an exploded view of the movement of the mechanical arm and the side view of the mechanical arm of the present invention.

FIG. 4 is a rear view of the present invention.

FIG. 5 is a side view of the mechanical arm of the present invention.

### DETAILED DESCRIPTION OF THE INVENTION

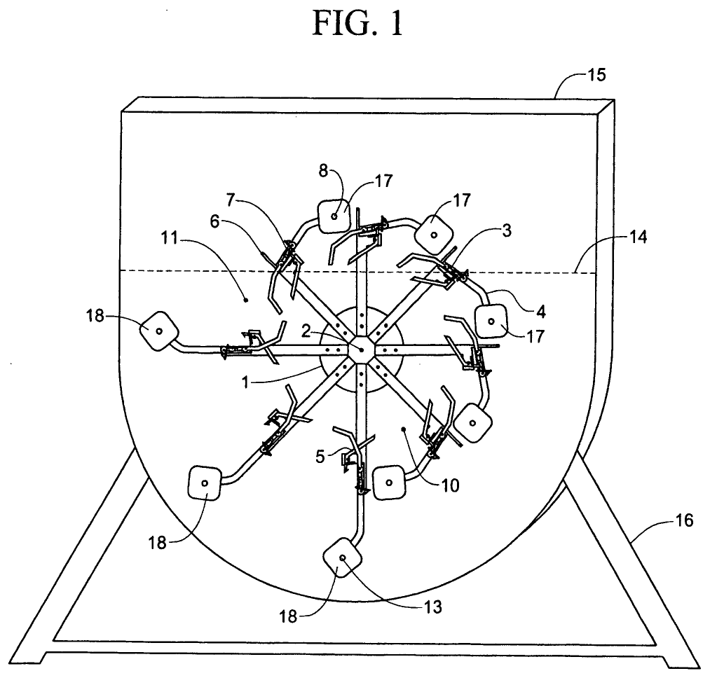

In referring to FIG. 1, line 1 represents the central disc. Line 2 represents the center of the central disc that is attached to eight mechanical arms. Each mechanical arm is fastened to the central disc by two screws. Central disc is held by the mechanical arms distributed in eight parts from the disc or the equivalent to a 45° angle. Line 3 represents the bottom portion of the mechanical arm in which the arm makes approximately 95° semi-rotations. The top portion of the arm, which is represented by line 4 remains steady and is secured to the central disc and operates by holding the top portion of the arm by a shaft. In the same way, a lever-hook is secured to the device; the lever-hook is fastened to bottom arm as it breaks away.

The bottom portion of the mechanical arm line 3 operates by contracting and protracting, shortening and lengthening the distance between the shaft at the very instant of entering and exiting the water. It is equipped with mechanisms that maintain it rigid at the time of coming out of the water and with other mechanisms that are maintained contracted when being immersed in the water. In addition, the bottom portion of the mechanical arm carries a shaft that secures a two-bodied lever hook that serves to hitch and maintain the arm extended as it comes out of the water. Line 4 represents the mechanical arm that holds a floater on one end. The floater is represented by line 8.

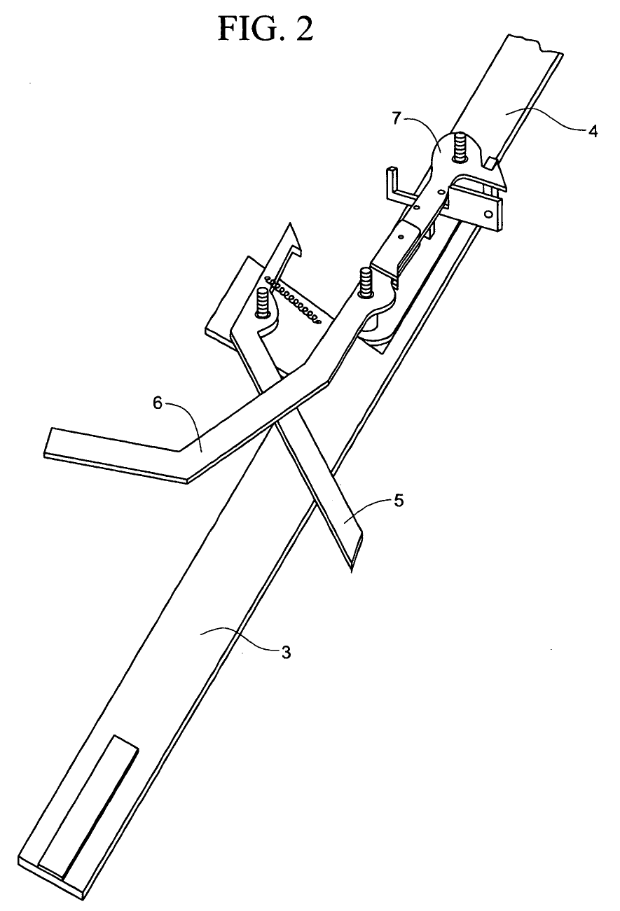

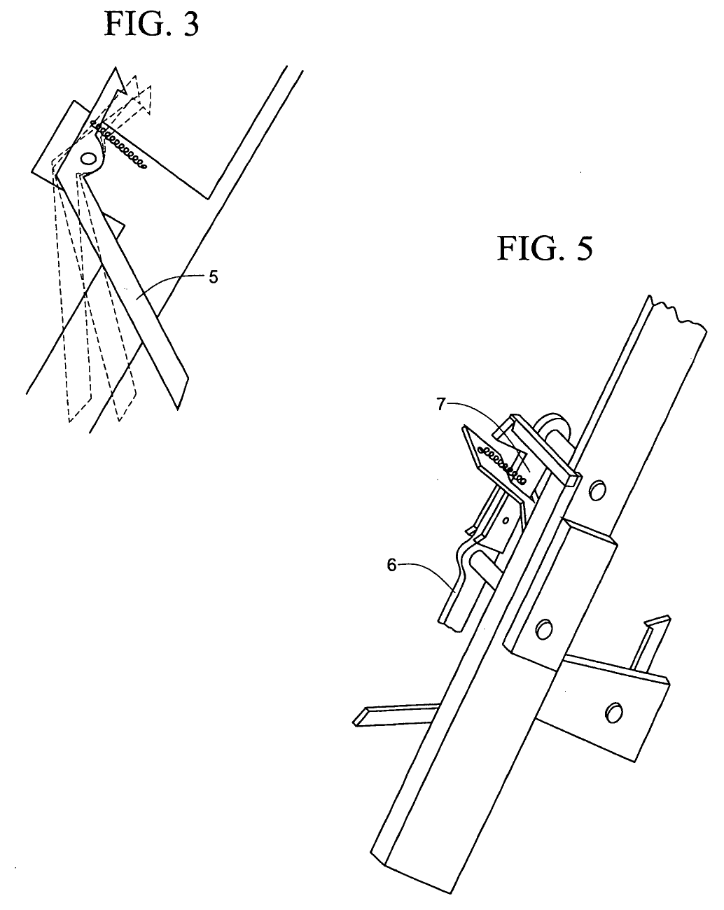

Line 5 represents the lever-hook that is secured by a shaft to the top portion of mechanical arm 4 and hitches onto arm 3 when it retracts and is immersed into the water; at certain times when activated during its course this lever-hook makes 45° (degree) semi-rotations on its shaft by a secure lever in the container. The lever-hook returns to its original position pulled by a spring. FIG. 2 and FIG. 3 provide a detailed view of the mechanical arms. During its course line 6 represents the two-bodied independent lever-hook is activated when the secure lever inside the container is pulled joining it to mechanical arm line 7 through a shaft in the same arm and another in the main shaft that joins arm 6 and arm 7; this two-bodied lever hook carries a shaft between both parts that operates as a balancing point in order to lever itself and free the hook that secures arm 6 while it is extended. Arm 6 returns to its original position pulled by a fastened spring.

During its course, the two-bodied independent lever-hook is activated when the secure lever inside the container is pulled joining it to mechanical arm 6 through a shaft in the same arm and another in the main shaft that joins arm 7 and arm 6; this two-bodied lever hook carries a shaft between both parts that operates as a balancing point in order to lever itself and free the hook that secures arm 6 while it is extended. Arm 6 returns to its original position pulled by a fastened spring. FIG. 2 and FIG. 3 provide a detailed view of arm 6 and arm 7. Line 8 represents an Elongated floater and semi-squared at the ends, fastened by arm 7 in the center, and at the ends it carries a mechanism in the form of semi-shafts that project 2 cm on each side and allow it to pass through a slider guiding it towards its protracting phase. The mechanical arm extends and passes floaters by means of its projecting semi-shafts. Line 10 represents the bottom slider or balancing point in which the lever-hook 5 is activated and is secured to the container's wall. Line 11 represents the top slider or balancing point in which hook-lever arms 6 and 7 is secured to the container's wall.

Line 13 Projects semi-shafts at one end, which allow the floaters to pass in order for the arm to extend. Line 14 represents the water level since the mechanical device is found immersed in a container of water and is joined to a shaft that crosses said device. The space without the water inside the container is at 9 inches and 62 cm from the top of the container. The water inside the container is permanently held at approximately 4/5 parts of its capacity to allow for the necessary empty space in which the arms must flex to begin from the water once again. This device has the capability to operate without requiring any other form of energy and does not demand constant hydro provisions since it does not require it. An additional quality of HIDROFLOT is that similar to the device's size it can generate more power by using it in a chain, in other words, different arrangements aligned in a larger container. HIDROFLOT does not need any other source of energy to begin its rotation. While the container fills up with water, the three active floaters 17 exert pressure so that the five passive floaters 18 will come out with the necessary force, thus entering and carrying out its operating cycles. HIDROFLOT can generate the required power by enlarging the device since the bigger the floaters, with their respective arms, the greater the power developed. The simplicity of this system is that it does not need any other type of force to stimulate it. It does not require another form of energy, and it can function permanently without creating heavy noise or contamination because it solely relies on water in a container. Line 16 represents the stand on which the container is put on two stands are at 13 inches and 0.50 cm and the width of the stand is at 46 inches. Line 15 represents the width of the container at 14 inches and 23 cm. The length of the container is represented by line 18 at 32 inches and 69 cm.

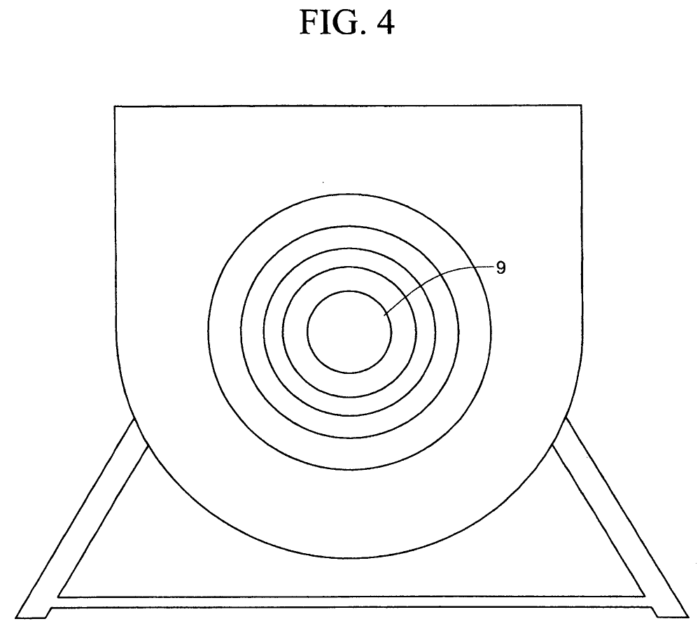

In referring to FIG. 2, arm 6 and arm 7 are joined together by two screws. Arm 5 is joined by arm 6 by a screw and pulled by its movement with a spring. In referring to FIG. 3, arm 5 displays the movement inside the container. In referring to FIG. 5 arms 6 and 7 are displayed as a side view. In referring to FIG. 4 in referring to line 9 the inactive disc functions on the outer part of the container and is attached to the device via the shaft that crosses the container; it operates by maintaining the rotors at a steady speed and for each rotation inside the container this disc rotates eight times.

1. The HIDROFLOT system is comprised of a central disc of which eight break-away mechanical arms are joined of which at the ends eight floaters are joined; connecting it all to a shaft that carries its rotation base fastened to the container's walls.

2. The shaft crosses the container at one outer end so that a tube measuring ¾ parts of the device's size is connected with the extended arms.

3. The tube is a metal disc with a fixed weight and for each rotation the device makes within the container, it rotates approximately eight times and operates by maintaining the rotors at a constant and balanced speed.

4. A line of simple mechanisms are fastened to the container's walls that work as harness points so that the mechanical arms can be activated and protracted or contracted depending on the situation.
